(19) United States
(12) Patent Application Publication
(10) Pub. No.: US 2026/0054662 A1
(43) Pub. Date: Feb. 26, 2026

(54) LICENSE PLATE FRAME FOR A DIGITAL LICENSE PLATE

(71) Applicant: Cruiser Accessories, LLC, Monument, CO (US)

(72) Inventors: Todd R. Spencer, Monument, CO (US); Mark Hunter Basenberg, JR., Colorado Springs, CO (US); Eldon L. Goates, Colorado Springs, CO (US)

(21) Appl. No.: 18/812,929

(22) Filed: Aug. 22, 2024

(51) Int. Cl. B60R 13/10

(52) U.S. Cl. CPC B60R 13/105

(57) ABSTRACT

A license plate frame is disclosed that is used to cover the perimeter of a digital license plate attached to a vehicle to provide a more aesthetic and finished appearance. The face of the license plate frame may be of any aesthetic or decorative appearance. Various methods and structures are disclosed that are used to attach the license plate frame to the digital license plate.

### BACKGROUND

### Field of the Invention

This application concerns license plate frames for use with a digital license plate that is attached to a vehicle.

### SUMMARY

This Summary is provided to introduce in a simplified form a selection of concepts that are further described below in the Detailed Description. This Summary is not intended to identify key or essential features of the claimed subject matter, nor is it intended to be used to limit the scope of the claimed subject matter.

The detailed description below describes various license plate frames and how they are attached to a digital license plate that is attached to a vehicle to provide a more aesthetic and finished appearance. The face of the license plate frame may be of any aesthetic or decorative appearance. The solution described below enables various attachment approaches to secure the license plate frame to the digital license plate.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together. When each one of A, B, and C in the above expressions refers to an element, such as X, Y, and Z, or class of elements, such as X1-Xm, Y1-Yn, and Z1-Zo, the phrase is intended to refer to a single element selected from X, Y, and Z, a combination of elements selected from the same class (e.g., X1 and X2) as well as a combination of elements selected from two or more classes (e.g., Y1 and Z3).

It is to be noted that the term “a entity” or “an entity” refers to one or more of that entity. As such, the terms “a” (or “an”), “one or more,” and “at least one” can be used interchangeably herein. It is also to be noted that the terms “comprising,” “including,” and “having” can be used interchangeably.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

### BRIEF DESCRIPTION OF THE SEVERAL VIEWS OF THE DRAWINGS

FIGS. 1A-F show various views of a license plate frame for a digital license plate in an embodiment of the invention.

FIGS. 2A-E show various views of a license plate frame for a digital license plate in another embodiment of the invention.

FIGS. 3A-E show various views of a license plate frame for a digital license plate in another embodiment of the invention.

FIGS. 4A-E show various views of a license plate frame for a digital license plate in another embodiment of the invention.

FIGS. 5A-E show various views of a license plate frame for a digital license plate in another embodiment of the invention.

FIGS. 6A-E show various views of a license plate frame for a digital license plate in another embodiment of the invention.

FIGS. 7A-E show various views of a license plate frame for a digital license plate in another embodiment of the invention.

FIGS. 8A-E show various views of a license plate frame for a digital license plate in another embodiment of the invention.

FIGS. 9A-E show various views of a license plate frame for a digital license plate in another embodiment of the invention.

FIGS. 10A-E show various views of a license plate frame for a digital license plate in another embodiment of the invention.

To assist in the understanding of the present disclosure the following list of components and associated numbering found in the drawings is provided herein:

Table of Components

| Component | # |
|---|---|
| digital license plate | 2 |
| license plate frame | 4 |
| adhesive strip | 6 |
| adhesive dot | 8 |
| edge | 10 |
| license plate frame | 12 |
| clip | 14 |
| barb | 16 |
| license plate frame | 18 |
| flange | 20 |
| license plate frame | 22 |
| digital mounting plate | 24 |
| license plate frame | 26 |
| screw studs | 28 |
| screw holes | 30 |
| nut | 32 |
| standard license plate frame | 34 |
| hole | 36 |
| license plate frame | 38 |
| adhesive tab | 40 |
| license plate frame | 42 |
| hole | 43 |
| top-hat shaped part | 44 |
| base flange | 46 |
| screw | 48 |
| license plate frame | 50 |
| supporting element | 52 |
| screw stud | 54 |
| nut | 56 |
| license plate frame | 58 |
| bracket | 60 |
| screw stud | 62 |
| nut | 64 |
| license plate frame | 66 |
| bracket | 68 |
| screw stud | 70 |
| nut | 72 |

### DETAILED DESCRIPTION

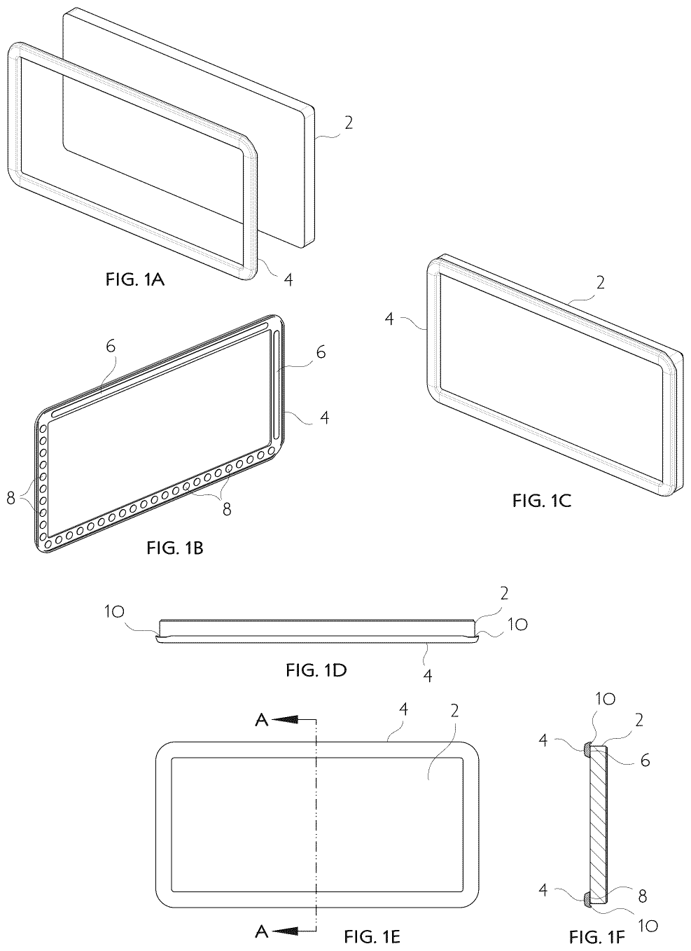

Referring now to the Figures, like reference numerals and names refer to structurally and/or functionally similar elements thereof, and if objects depicted in the figures that are covered by another object, as well as the tag line for the element number thereto, may be shown in dashed lines. FIGS. 1A-F show various views of a license plate frame for a digital license plate in an embodiment of the invention. Referring now to FIGS. 1A-F, license plate frame 4 is designed to cover the perimeter of the front face of digital license plate 2 to provide a more aesthetic and finished appearance. The face of license plate frame 4 (see FIG. 1A) may be of any aesthetic or decorative appearance. Digital license plate 2 has its own attachment mechanism to attach to a vehicle. The back side of license plate frame 4 (see FIG. 1B) utilizes an attachment means, such as a “peel-and-stick” or glue based or double sided tape to adhere the license plate frame 4 to the digital license plate 2. The attachment means may be full adhesive strips 6, or adhesive dots 8 distributed along the back side of license plate frame 4, or a combination of the two as shown. License plate frame 4 may or may not be limited to the size of the digital license plate 2. In this embodiment the edges 10 of the license plate frame 4 extend beyond and slightly wrap around the front edge of the digital license plate 2. In other embodiments the edges of the license plate frame 4 do not extend beyond or slightly wrap around the edge of the digital license plate 2. FIG. 1F is a cross-section view when viewed along line A-A shown in FIG. 1E.

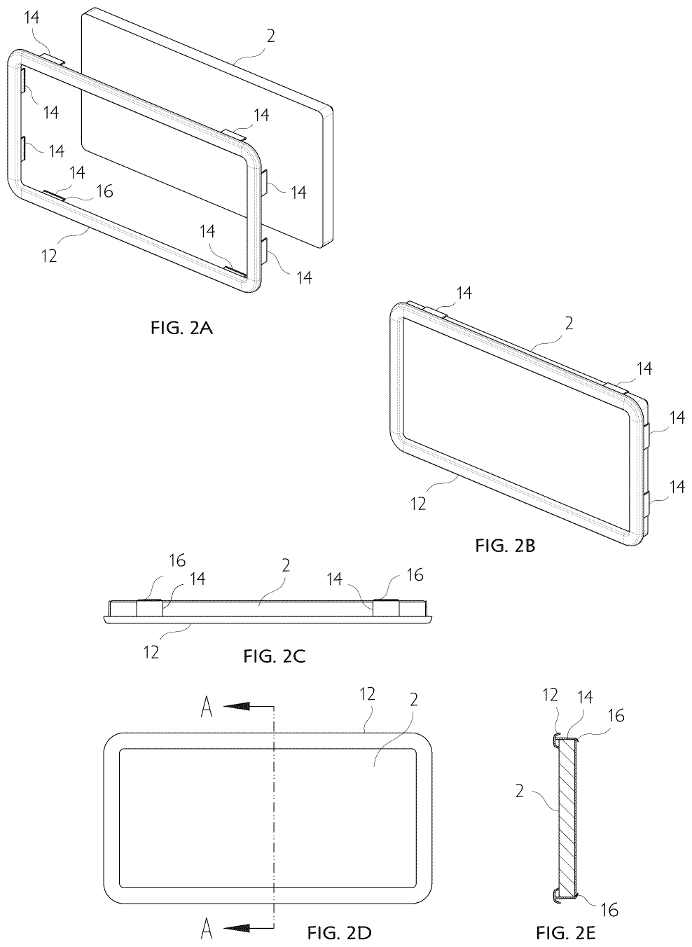

FIGS. 2A-E show various views of a license plate frame for a digital license plate in another embodiment of the invention. Referring now to FIGS. 2A-E, license plate frame 12 is designed to cover the perimeter of digital license plate 2 to provide a more aesthetic and finished appearance. The face of license plate frame 12 may be of any aesthetic or decorative appearance. Digital license plate 2 has its own attachment mechanism to attach to a vehicle. The back side of license plate frame 12 utilizes a plurality of clips 14 spaced around the perimeter of license plate frame 12 as an attachment means. Each clip 14 has a flex quality such that each clip 14 can be flexed over and grip onto the outer edges of digital license plate 2 with a barb 16 and thus secure license plate frame 12 to digital license plate 2. FIG. 2E is a cross-section view when viewed along line A-A shown in FIG. 2D.

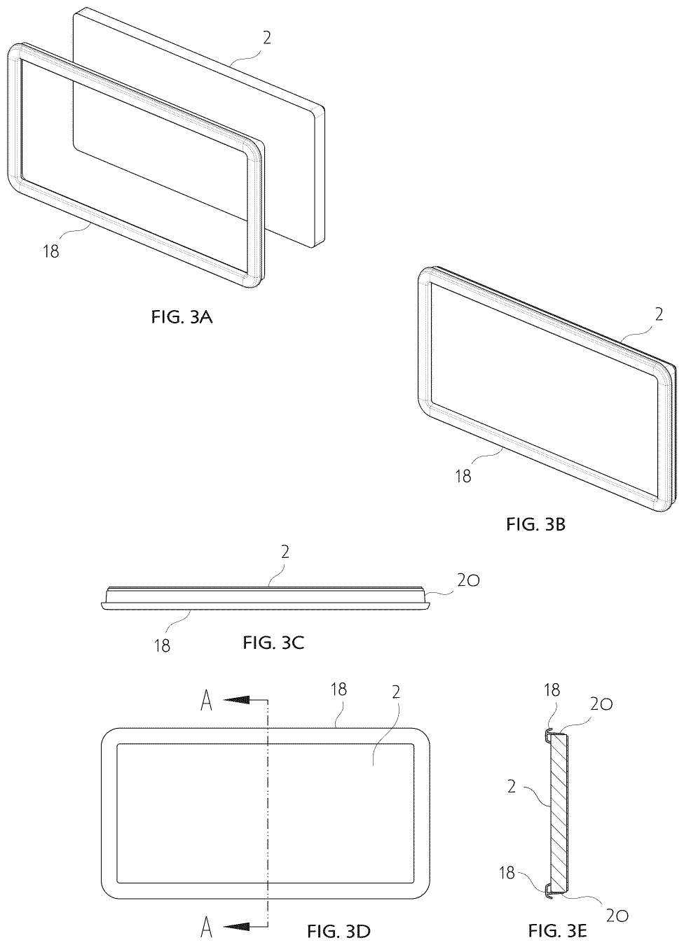

FIGS. 3A-E show various views of a license plate frame for a digital license plate in another embodiment of the invention. Referring now to FIGS. 3A-E, license plate frame 18 is designed to cover the perimeter of digital license plate 2 to provide a more aesthetic and finished appearance. The face of license plate frame 18 may be of any aesthetic or decorative appearance. Digital license plate 2 has its own attachment mechanism to attach to a vehicle. License plate frame 18 is very similar in function to license plate frame 12 but instead it has a tight fitting continuous perimeter flange 20 to “grab” the outer edges of digital license plate 2. The back side of license plate frame 18 utilizes a continuous flange 20 around the perimeter of the license plate frame 18 that is flexed over and grips onto the outer edges of digital license plate 2 because of the friction caused by the tight fit and thus secure license plate frame 18 to digital license plate 2. FIG. 3E is a cross-section view when viewed along line A-A shown in FIG. 3D.

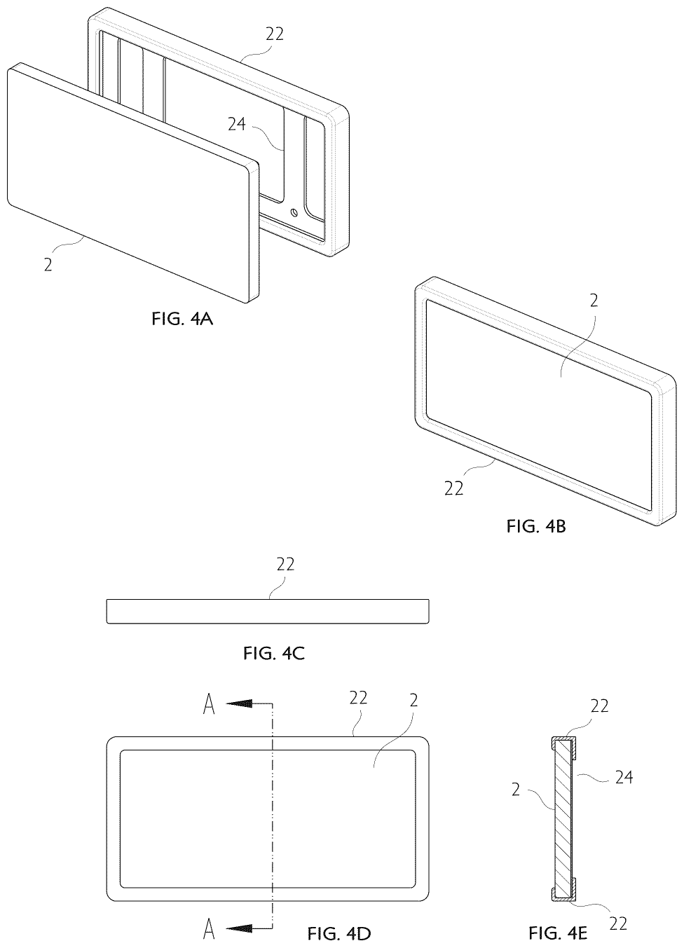

FIGS. 4A-E show various views of a license plate frame for a digital license plate in another embodiment of the invention. Referring now to FIGS. 4A-E, license plate frame 22 is designed to cover the perimeter of digital license plate 2 to provide a more aesthetic and finished appearance. The face of license plate frame 22 may be of any aesthetic or decorative appearance. A stretchy polymer such as silicone or rubber base material is molded such that the inside surfaces will fit over the digital license plate 2. The silicone or rubber expands to fit around the digital license plate 2, then when positioned correctly envelops all the surfaces perpendicular to the display face of digital license plate 2 and wraps aesthetically over the edges of the display face of digital license plate 2. License plate frame 22 leaves an open area for visibility to the display face of the digital license plate 2 on the front side, then wraps around the edges of the back while still allowing screws from the mounting plate 24 to pass through. Assembly is done by fitting the license plate frame 22 around a perimeter of the digital mounting plate 24 of the digital license plate 2, then attaching the digital mounting plate 24 to the vehicle with the back portion of the license plate 22 sandwiched between the vehicle and the digital mounting plate 24. The digital license plate 2 is then assembled as usual to the digital mounting plate 24 while stretching and working around the license plate frame 22. Once mounted, the license plate frame 22 is worked around the digital license plate 2 to set and wrap the edges of the license plate frame 22. FIG. 4E is a cross-section view when viewed along line A-A shown in FIG. 4D.

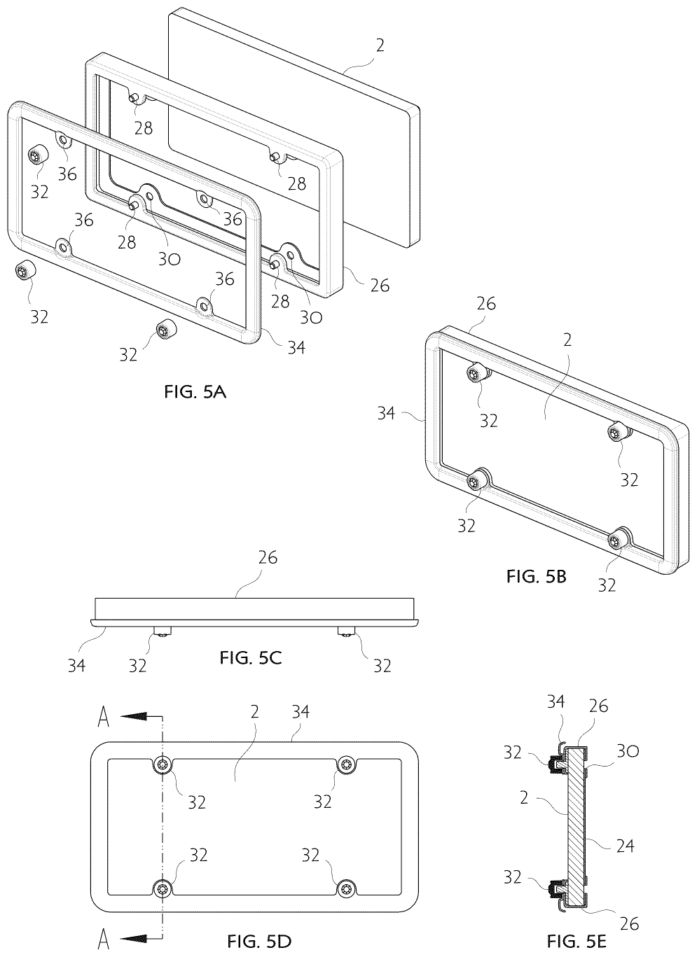

FIGS. 5A-E show various views of a license plate frame for a digital license plate in another embodiment of the invention. Referring now to FIGS. 5A-E, assembly is done by placing the license plate frame 26 made of a stretchy polymer such as silicone or rubber base material and molded such that the inside surfaces will fit over the digital license plate 2 and around the digital mounting plate 24 (shown in FIG. 4A and FIG. 5E). The mounting plate 24 is attached the to the vehicle by sandwiching the back portion of the license plate frame 26 between the vehicle and the mounting plate 24. The digital license plate 2 is then assembled as usual to the mounting plate 24 while stretching and working the license plate frame 26 around the digital license plate 2. License plate frame 26 has four screw studs 28 that are molded into and extend out of the front side of license plate frame 26. There are four screw holes 30 that are molded into the back side of license plate frame 26. The holes 30 allow screws or another type of fastener (not shown in FIG. 5A) to fasten the mounting plate 24 shown in FIG. 5E to the vehicle. The holes 30 also align with the four screw studs 28. The four screw studs 28 accept nuts 32 which may be decorative or plain, and blind or through, which secure a standard license plate frame 34 to the license plate frame 26 which is secured to the digital license plate 2. Standard license plate frame 34 also has four holes 36 that align with the four screw studs 28 and the four screw holes 30. In this embodiment, license plate frame 26 is supportive and standard license plate frame 34 is decorative. FIG. 5E is a cross-section view when viewed along line A-A shown in FIG. 5D.

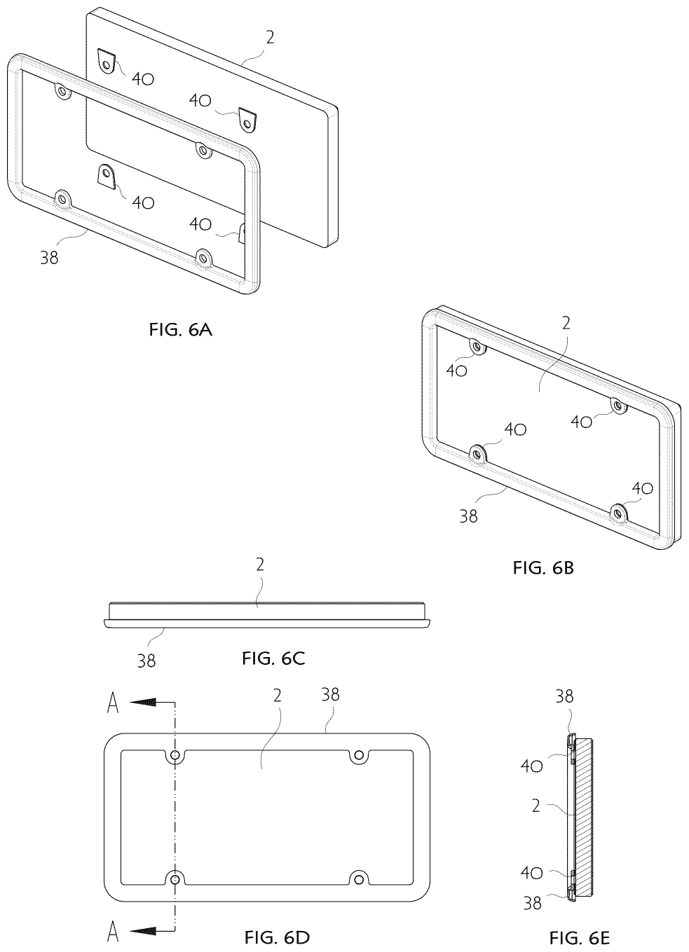

FIGS. 6A-E show various views of a license plate frame for a digital license plate in another embodiment of the invention. Referring now to FIGS. 6A-E, license plate frame 38 is designed to cover the perimeter of digital license plate 2 to provide a more aesthetic and finished appearance. The face of license plate frame 38 may be of any aesthetic or decorative appearance. Adhesive tabs 40 are utilized to secure license plate frame 38 to digital license plate 2. Adhesive tabs 40 may be a “peel-and-stick” type adhesive where a protective layer is peeled off of both sides so one side adheres to license plate frame 38 and the other side adheres to digital license plate 2. Adhesive tabs 40 may also be a two-sided tape adhesive or a double-sided foam tape adhesive. FIG. 6E is a cross-section view when viewed along line A-A shown in FIG. 6D.

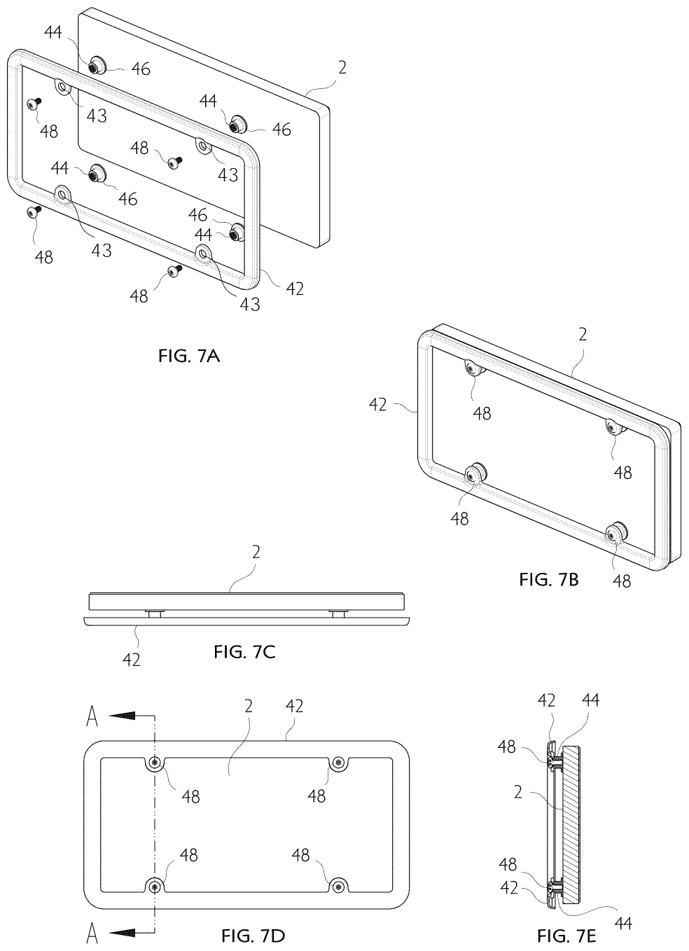

FIGS. 7A-E show various views of a license plate frame for a digital license plate in another embodiment of the invention. Referring now to FIGS. 7A-E, license plate frame 42 is designed to cover the perimeter of digital license plate 2 to provide a more aesthetic and finished appearance. The face of license plate frame 42 may be of any aesthetic or decorative appearance. A top-hat shaped part 44 has screw threads on the inside and a wider base flange 46 that is attached to the digital license plate 2 utilizing a “peel-and-stick” type adhesive, or a two-sided tape adhesive, or a double-sided foam tape adhesive as disclosed in the discussion above regarding FIGS. 6A-E. Screws 48 pass through holes 43 formed in license plate frame 42 and into the internally threaded top-hat shaped parts 44. There is some space between the digital license plate 2 and the license plate frame 42 dictated by the needed thread engagement of the screws 48 into the top-hat shaped parts 44. FIG. 7E is a cross-section view when viewed along line A-A shown in FIG. 7D.

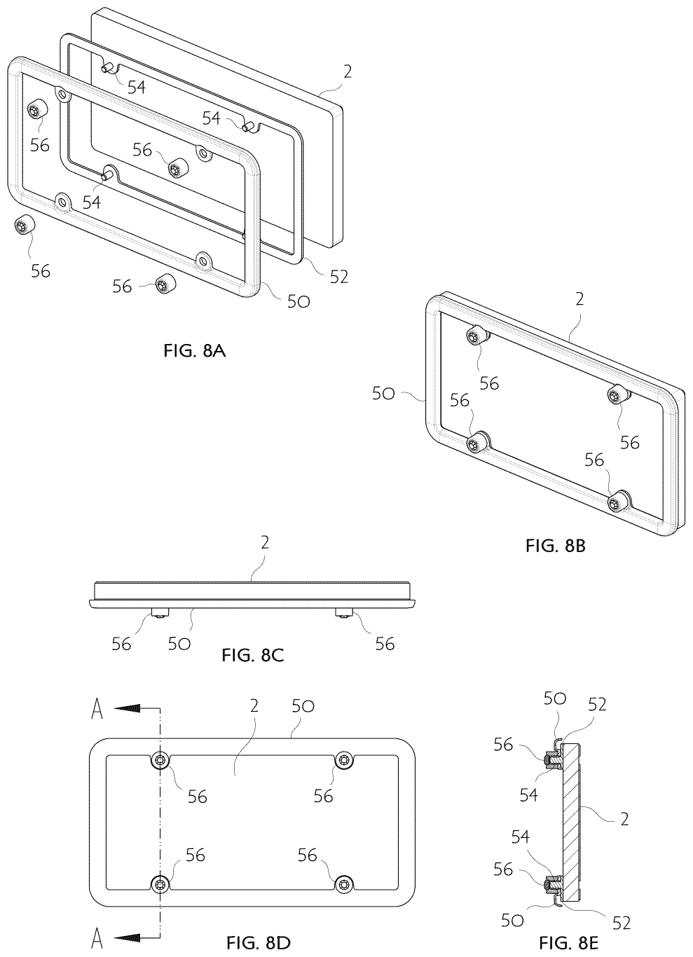

FIGS. 8A-E show various views of a license plate frame for a digital license plate in another embodiment of the invention. Referring now to FIGS. 8A-E, license plate frame 50 is designed to cover the perimeter of digital license plate 2 to provide a more aesthetic and finished appearance. The face of license plate frame 50 may be of any aesthetic or decorative appearance. A supporting element 52 attaches to the digital license plate 2 utilizing an attachment means, such as a “peel-and-stick” or glue based or double sided tape to adhere the supporting element 52 to the digital license plate 2. As disclosed in the discussion above regarding FIGS. 1A-E, the attachment means may be full adhesive strips or adhesive dots distributed along the back side of supporting element 52, or a combination of the two. Supporting element 52 has screw studs 54 protruding out from the front side. Screw studs 54 are aligned to pass through holes formed in license plate frame 50 and extending outward that receive nuts 56 for attaching license plate frame 50 to the supporting element 52 which is attached to the digital license plate 2. Nuts 56 may be decorative or not, blind or through. FIG. 8E is a cross-section view when viewed along line A-A shown in FIG. 8D.

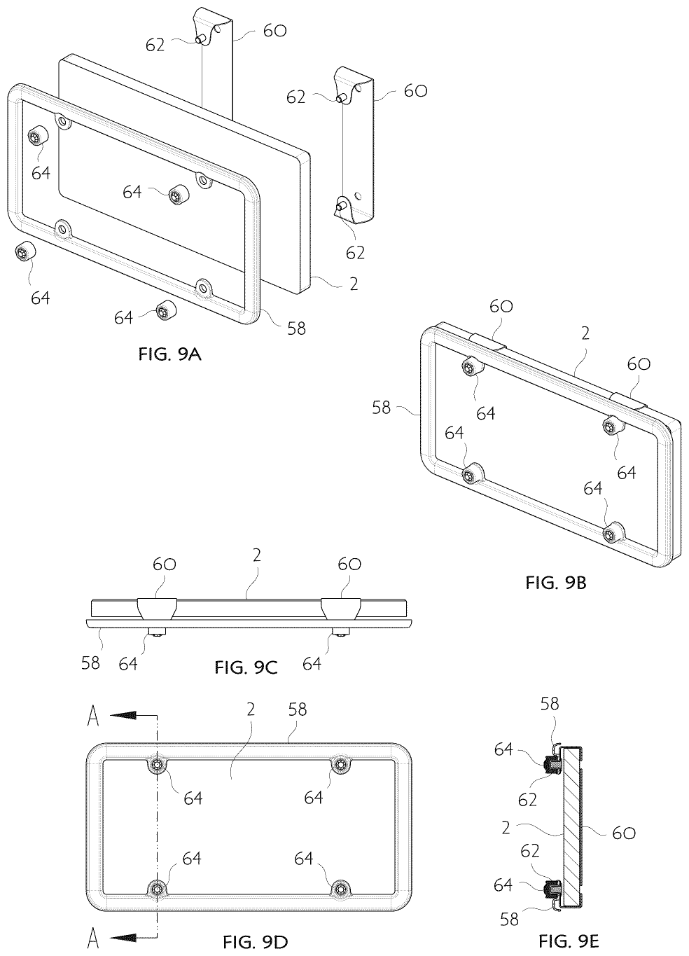

FIGS. 9A-E show various views of a license plate frame for a digital license plate in another embodiment of the invention. Referring now to FIGS. 9A-E, license plate frame 58 is designed to cover the perimeter of digital license plate 2 to provide a more aesthetic and finished appearance. The face of license plate frame 58 may be of any aesthetic or decorative appearance. A pair of brackets 60 are attached to the vehicle and then the digital license plate 2 is positioned within the brackets 60. Screw studs 62 are aligned to pass through holes formed in license plate frame 58 and extending outward that receive nuts 64 for attaching license plate frame 58 to the brackets 60 which are attached to the vehicle. Nuts 64 may be decorative or not, blind or through. FIG. 9E is a cross-section view when viewed along line A-A shown in FIG. 9D.

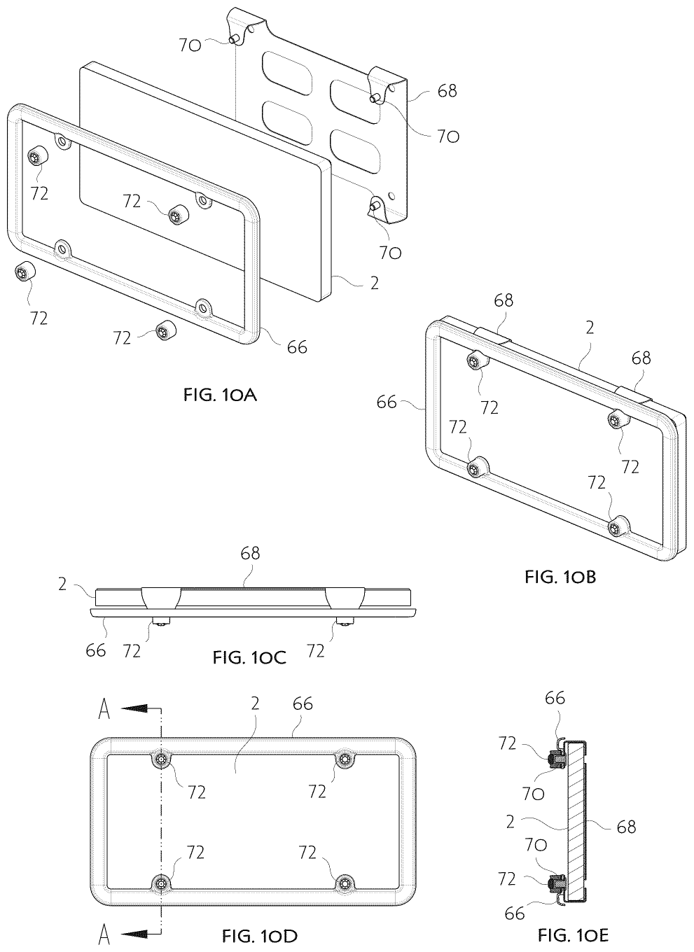

FIGS. 10A-E show various views of a license plate frame for a digital license plate in another embodiment of the invention. Referring now to FIGS. 10A-E, license plate frame 66 is designed to cover the perimeter of digital license plate 2 to provide a more aesthetic and finished appearance. The face of license plate frame 66 may be of any aesthetic or decorative appearance. Bracket 68 is attached to the vehicle and then the digital license plate 2 is positioned within the bracket 68. Screw studs 70 are aligned to pass through holes formed in license plate frame 66 and extending outward that receive nuts 72 for attaching license plate frame 66 to the bracket 68 which are attached to the vehicle. Nuts 72 may be decorative or not, blind or through. FIG. 10E is a cross-section view when viewed along line A-A shown in FIG. 10D.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications will suggest themselves without departing from the scope of the disclosed subject matter.

What is claimed is:

1. A license plate frame for a digital license plate comprising:
a license plate frame configured to cover a perimeter of a digital license plate; and
an attachment means for attaching the license plate frame to the digital license plate.

2. The license plate frame for a digital license plate according to claim 1 wherein the attachment means is at least one of: a plurality of adhesive strips and a plurality of adhesive dots that are distributed along the back side of the license plate frame that adhere the license plate frame to the digital license plate.

3. The license plate frame for a digital license plate according to claim 1 wherein the attachment means is a plurality of clips spaced around a back side of the license plate frame that flex over and grip onto an outer edges of the digital license plate.

4. The license plate frame for a digital license plate according to claim 1 wherein the attachment means is a continuous flange around the perimeter of the back side of the license plate frame that is flexed over and grips onto an outer edges of the digital license plate.

5. The license plate frame for a digital license plate according to claim 1 wherein the attachment means is a plurality of adhesive tabs located on a back side of the license plate frame that adhere the license plate frame to the digital license plate.

6. A license plate frame for a digital license plate comprising:
a license plate frame made from at least one of: a silicone and a rubber, and configured to stretch over a perimeter of a digital license plate, and configured to fit around a perimeter of a digital mounting plate, wherein a back portion of the license plate frame is sandwiched between a vehicle and the digital mounting plate.

7. A license plate frame for a digital license plate comprising:
a license plate frame made from at least one of: a silicone and a rubber, and configured to stretch over a perimeter of a digital license plate, and configured to fit around a perimeter of a digital mounting plate, wherein a back portion of the license plate frame is sandwiched between a vehicle 4 and the digital mounting plate;
a plurality of screw studs molded into and extending out of the front side of the license plate frame;
a standard license plate frame having a plurality of holes that align with and receive the plurality of screw studs; and
a plurality of nuts which screw onto the plurality of screw studs and secure the standard license plate frame to the license plate frame which is secured to the digital license plate.

8. A license plate frame for a digital license plate comprising:
a license plate frame having a plurality of holes molded therein;
a plurality of top-hat shaped parts with internal screw threads and having a wider base flange, wherein the wider base flange is attached to the digital license plate utilizing at least one of: a “peel-and-stick” type adhesive, a two-sided tape adhesive, and a double-sided foam tape adhesive; and
a plurality of screws that pass through the plurality of holes securing the license plate frame to the digital license plate and creating a space between the license plate frame and the digital license plate.

9. A license plate frame for a digital license comprising:
a license plate frame having a plurality of holes molded therein and configured to cover a perimeter of a digital license plate;
an attachment means for attaching the license plate frame to the digital license plate.

10. The license plate frame for a digital license plate according to claim 9 wherein the attachment means is a supporting element that attaches to the digital license plate utilizing at least one of: a “peel-and-stick” type adhesive, a two-sided tape adhesive, and a double-sided foam tape adhesive on a back side of the supporting element, the supporting element having a plurality of screw studs that protrude out from the front side of the supporting element and are aligned to pass through the plurality of holes formed in license plate frame; and
a plurality of nuts received on the plurality of screw studs for attaching the license plate frame to the supporting element which is attached to the digital license plate.

11. The license plate frame for a digital license plate according to claim 9 wherein the attachment means is a pair of brackets and the digital license plate is positioned within the pair of brackets, the pair of brackets having a plurality of screw studs that protrude out from the front side of the pair of brackets and are aligned to pass through the plurality of holes formed in license plate frame; and
a plurality of nuts received on the plurality of screw studs for attaching the license plate frame to the pair of brackets and securing the pair of brackets to the digital license plate.

12. The license plate frame for a digital license plate according to claim 9 wherein the attachment means is a bracket and the digital license plate is positioned within the bracket, the bracket having a plurality of screw studs that protrude out from the front side of the bracket and are aligned to pass through the plurality of holes formed in license plate frame; and
a plurality of nuts received on the plurality of screw studs for attaching the license plate frame to the bracket and securing the brackets to the digital license plate.
